(19) United States
(12) Patent Application Publication
(10) Pub. No.: US 2009/0016306 A1
(43) Pub. Date: Jan. 15, 2009

(54) METHOD AND SYSTEM FOR AN EFFICIENT TIM ELEMENT SUPPORTING MULTIPLE BSSes IN A WIRELESS LAN

(76) Inventors: Qi Wang, Sunnyvale, CA (US); Raymond Hayes, Los Gatos, CA (US)

Correspondence Address: MCANDREWS HELD & MALLOY, LTD, 500 WEST MADISON STREET, SUITE 3400, CHICAGO, IL, 60661, US

(21) Appl. No.: 11/939,711

(22) Filed: Nov. 14, 2007

Related U.S. Application Data
(60) Provisional application No. 60/949,422, filed on Jul. 12, 2007.

(51) Int. Cl. H04Q 7/24

(52) U.S. Cl. 370/338

(57) ABSTRACT

Aspects of a system for an efficient traffic indication map (TIM) element supporting multiple basic service sets (BSSes) in a wireless LAN may include an access point (AP) the enables generation of a traffic indication virtual bitmap based on the presence of stored data pending transmission to one or more WLAN stations (STAs) via a wireless communication medium. The AP may generate a partial virtual bitmap based on the generated traffic indication virtual bitmap. The partial virtual bitmap may comprise a first segment and a second segment, wherein each segment may be derived from the generated traffic indication virtual bitmap.

### CROSS-REFERENCE TO RELATED APPLICATIONS/INCORPORATION BY REFERENCE

This application makes reference to, claims priority to, and claims the benefit of U.S. Provisional Application Ser. No. 60/949,422, filed on Jul. 12, 2007, which is hereby incorporated herein by reference in its entirety.

### FIELD OF THE INVENTION

Certain embodiments of the invention relate to communication networks. More specifically, certain embodiments of the invention relate to a method and system for an efficient traffic indication map (TIM) element supporting multiple basic service sets (BSSes) in a wireless LAN.

### BACKGROUND OF THE INVENTION

IEEE 802.11 describes a communication architecture, which may enable computing devices to communicate via wireless local area networks (WLANs). One of the building blocks for the WLAN is the basic service set (BSS). A BSS may comprise a plurality of computing devices, or stations (STA), which may communicate wirelessly via one or more RF channels within a coverage area. The span of a coverage area may be determined based on the distance over which a source STA may transmit data via an RF channel, which may be received by a destination STA.

An independent BSS (IBSS) refers to a BSS, which comprises a set of STAs, which may communicate with each over within the coverage area for the BSS. In an IBSS each STA may engage in direct communication with any of the other STAs within the IBSS. An IBSS may be referred to as an ad hoc network.

An infrastructure BSS refers to a BSS, which is one of a plurality of BSSes, which are associated in a larger network referred to as an extended service set (ESS). The ESS is identified by a service set identifier (SSID). An infrastructure BSS may also be referred to as a BSS. Each of the BSSs within an ESS is identified by a BSS identifier (BSSID). Thus, STAs within a BSS generally determine their association within the BSS based on a BSSID and an SSID.

Communication between BSSs occurs via a distribution system (DS). The DS may utilize wired and/or wireless communication technologies. A BSS is able to establish communication to the DS via an access point (AP). The AP is a member of the BSS.

Each BSS comprises a plurality of STAs and an AP. The AP forms an association with each of the STAs within the BSS. The AP identifies each association by an association identifier (AID). The AP may provide communication services to STAs within a BSS based on the presence of an established association.

Within an infrastructure BSS, communication between STAs typically occurs via the AP. For example, when a STA_A within the BSS attempts to communicate with a STA_B within the BSS, the STA_A sends data to an AP_1, which subsequently sends the data to the STA_B. When the STA_A within BSS_1 attempts to communicate with a STA_X within a BSS_2, the STA_A sends data to the AP_1 within BSS_1. The AP_1 sends the data via the DS to an AP_2 within the BSS_2. The AP_2 sends the data to the STA_X within the BSS_2.

Within a BSS or IBSS, a STA may operate in two power management modes: an active mode (AM) and/or a power-save mode (PS). When the STA is operating in an AM, the STA may be fully powered (within the capabilities of the power supply, for example) and may transmit and/or receive data. When the STA is operating in PS mode, the STA may enter a doze state during which it operates at lower power consumption (when compared to AM) and capabilities for receiving data may be disabled. In an IBSS, a STA communicates its current power management mode to each of the other STAs within the IBSS. In a BSS, a STA communicates its current power management mode to the AP.

When a STA within a BSS is operating in an AM, the AP may send data to the STA. When the STA is operating in PS mode, the AP may store, or buffer, data, which is to be sent to the STA. At determined time intervals, the AP transmits beacon frames to the STAs within the BSS. STAs, which are operating in PS mode, may depart from the doze state during these time intervals to receive the beacon frames. The beacon frames may comprise a traffic indication map (TIM) information element. The TIM element comprises data, which indicates whether the AP is currently buffering data for one or more STAs within the BSS. Beacon frames may comprise a delivery TIM (DTIM) element. In the TIM element, a DTIM count enables the determination of whether the beacon frame contains a TIM or DTIM. When DTIM count equals 0, the TIM element is a DTIM element. In addition to the buffered unicast indication, a DTIM element comprises data which also allows the STAs to determine whether the AP is currently buffering data to be broadcast or multicast to a plurality of STAs within the BSS. The TIM (DTIM) element comprises a plurality of indicators, which are located based on an AID. For example, a STA may determine whether the AP is currently buffering unicast data by indexing the TIM or DTIM data based on the AID assigned to the STA for its association with the AP. Additionally, a STA may determine whether the AP is currently buffering broadcast and multicast data by indexing the DTIM data based on the AID designated for the buffered broadcast and multicast traffic indication for the BSS.

A single AP may be able to support multiple BSSes. The AP may share the entire AID space for all associated STAs. A subset of the AIDs may not be allocated to any individual STA. Instead, each of these AIDs may be used as the index value of the bitmap in a DTIM element to indicate the presence of buffered broadcast and multicast frames destined to the corresponding BSS among a plurality of BSSes. The number of these AIDs used for buffered broadcast and multicast frames indication may be determined by the total number of multiple BSSes supported by the AP. The AP may transmit a single beacon including a TIM or a DTIM element to multiple BSSes. The TIM or DTIM element may indicate the presence of unicast frames buffered for the STAs associated with the AP. The DTIM element may also indicate the presence of broadcast/multicast frames buffered for the BSSes supported by the AP.

When a STA determines that broadcast and multicast data is being buffered at the AP, the STA may leave the doze state to receive the buffered data. When a STA determines that unicast data is buffered at the AP, the STA may enter AM or poll the AP to receive the buffered data.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and system for an efficient traffic indication map (TIM) element supporting multiple basic service sets (BSSes) in a wireless LAN, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary system for wireless data communication, which may be utilized in connection with an embodiment of the invention.

FIG. 2 is a block diagram illustrating an exemplary system for wireless data communication in which a single access point supports multiple basic service sets, which may be utilized in connection with an embodiment of the invention.

FIG. 3A is a block diagram for an exemplary beacon frame format, which may be utilized in connection with an embodiment of the invention.

FIG. 3B is a block diagram for an exemplary beacon frame body format, which may be utilized in connection with an embodiment of the invention.

FIG. 3C is a block diagram for an exemplary traffic indication map information element, which may be utilized in connection with an embodiment of the invention.

FIG. 3D is a block diagram for an exemplary bitmap control field, which may be utilized in connection with an embodiment of the invention.

FIG. 4 is a diagram illustrating exemplary generation of a partial virtual bitmap for an access point, which has buffered unicast frames but may or may not have buffered broadcast/multicast frame, in accordance with an embodiment of the invention.

FIG. 5 is a diagram illustrating exemplary generation of a partial virtual bitmap for an access point, which has buffered broadcast/multicast frames but no buffered unicast frames, in accordance with an embodiment of the invention.

FIG. 6 is a diagram illustrating exemplary generation of a partial virtual bitmap for an access point, which has no buffered frames, in accordance with an embodiment of the invention.

FIG. 7 is a flowchart illustrating exemplary steps for the construction of an efficient TIM element supporting multiple BSSes in a WLAN, in accordance with an embodiment of the invention.

FIG. 8 is a flowchart illustrating exemplary steps for the interpretation of a TIM or DTIM element from a received beacon frame and the determination of whether a STA has buffered frames at an AP, in accordance with an embodiment of the invention.

### DETAILED DESCRIPTION OF THE INVENTION

Certain embodiments of the invention may be found in a method and system for an efficient traffic indication map (TIM) information element supporting multiple basic service sets (BSSes) in a wireless LAN. Various embodiments of the invention comprise a method and system for coding of a partial virtual bitmap (PVB) field within the TIM information element in a transmitted beacon frame that may reduce the quantity of data (as measured in binary bits, for example) contained within the TIM information element. Various embodiments of the invention may enable a single coded TIM information element to provide traffic indication data for a plurality of basic service sets (BSSes). In this aspect of the invention, a single access point (AP) may use a single association identifier (AID) space for STAs associate with any of the supported BSSes. This capability may enable the single AP to communicate traffic information data via the TIM element.

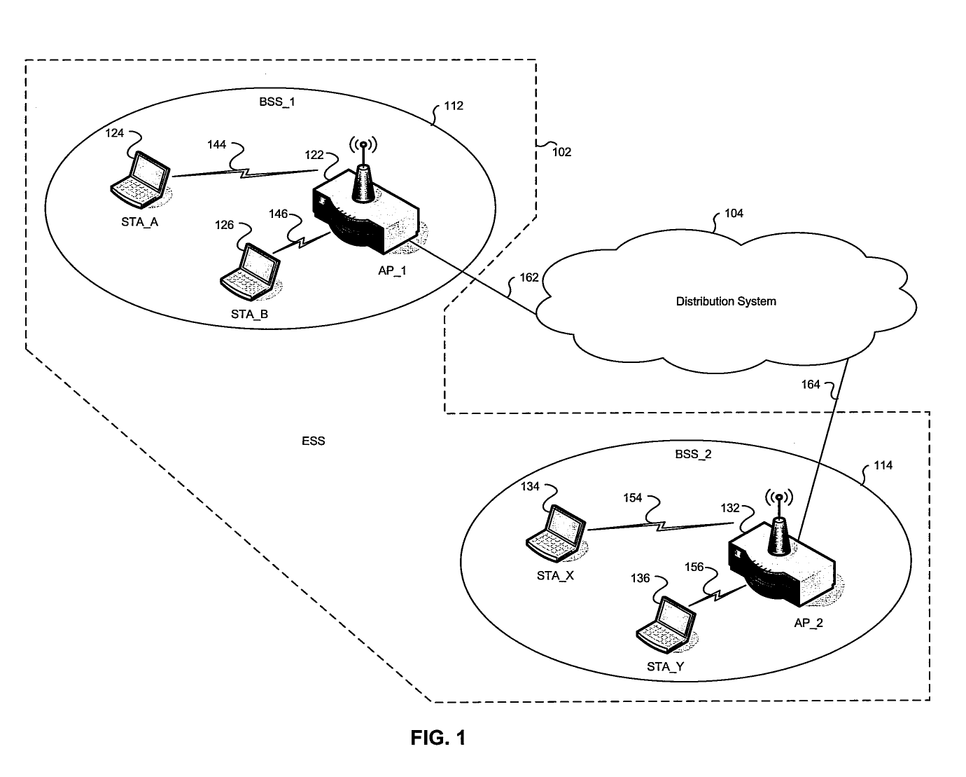

FIG. 1 is a block diagram of an exemplary system for wireless data communication, which may be utilized in connection with an embodiment of the invention. Referring to FIG. 1, there is shown an ESS 102 and a distribution system (DS) 104. The ESS 102 comprises a BSS_1 112 and a BSS_2 114. The BSS_1 112 comprises an AP_1 122, a WLAN station STA_A 124 and a STA_B 126. The BSS_2 114 comprises an AP_2 132, a STA_X 134 and a STA_Y 136.

The ESS 102 may be identified by an SSID=SSID₀, for example. The BSS_1 112 may be identified by a BSSID=BSSID₁, for example. The BSS_2 114 may be identified by a BSSID=BSSID₂, for example. The association between the STA_A 124 and the AP_1 122 may be identified by an AID=1, for example. The association between the STA_B 126 and the AP_1 122 may be identified by an AID=2, for example. The association between the STA_X 134 and the AP_2 132 may be identified by an AID=1, for example. The association between the STA_Y 136 and the AP_2 132 may be identified by an AID=2, for example.

The DS 104 may provide an infrastructure, which may be utilized to enable any of the STAs within the BSS_1 112 to communicate with any of the STAs within BSS_2 114, or vice versa. The DS 104 may utilize wireless communication (for example, via one or more RF channels), wired communication (for example, via copper or optical fiber cabling) or a combination thereof.

Within BSS_1 112, the AP_1 122 may communicate with STA_A 124 via one or more RF channels 144. The AP_1 122 may communicate with STA_B 126 via one or more RF channels 146. The STA_A 124 may communicate with STA_B 126 by sending a frame to the AP_1 122. Upon receipt of the frame, the AP_1 122 may determine that the destination for the frame is STA_B 126. The AP_1 122 may then send the frame to the STA_B 126. Within BSS_2 114, the AP_2 132 may communicate with STA_X 134 via one or more RF channels 154. The AP_2 132 may communicate with STA_Y 136 via one or more RF channels 156. STA_X 134 and STA_Y 136 may communicate in a manner, which is substantially similar to that described for STA_A 124 and STA_B 126.

Once the AP_1 122 has established associations between STA_A 124 and STA_B 126, AP_1 122 may communicate reachability information to the AP_2 132 via the DS 104. The reachability information may enable the AP_2 132 to determine a route by which frames may be delivered to the STA_A 124 and/or STA_B 126. For example, if the STA_X 134 sends a frame to the AP_2 132 for which the destination address identifies STA_A 124, the AP_2 132 may send the frame to the AP_1 122 via the DS 104. The interface 164 over which the AP_2 132 sends the frame to the DS 104 may utilize a wired interface (such as copper or optical fiber cabling) and/or wireless interface (such as one or more RF channels). Similarly, the interface 162 over which the AP_1 122 receives the frame from the DS 104 may utilize a wired interface and/or wireless interface.

AP_1 122 has the knowledge of the power management mode of STA_A 124 and STA_B 126. When the AP_1 122 receives the frame and determines that the destination for the frame is STA_A 124, if the AP_1 122 identifies that the STA_A 124 is in an active mode, the AP_1 122 may send the frame to the STA_A 124 via one or more RF channels 144. If the AP_1 122 identifies that the STA_A 124 is in a power-save (PS) mode, the AP_1 122 may store the frame as a buffered frame, EF_{buf}(1). The AP_1 122 may utilize the AID value AID=1 associated with the STA_A 124 as an index for the buffered frame, EF_{buf}(1).

At various times, the AP_1 122 may attempt to transmit data to a plurality of STAs. For example, the AP_1 122 may transmit a frame to the STA_A 124 and STA_B 126 within the BSS_1 112 via a multicast or broadcast. When the AP_1 122 identifies that the STA_A 124 and STA_B 126 are both in the active mode, the AP_1 122 may multicast or broadcast the frame to STA_A 124 and STA_B 126 via one or more broadcast RF channels. When the AP_1 122 identifies that any one of the STAs, for example STA_A 124, is in a PS mode, the AP_1 122 may store the broadcast frame as a buffered frame, EF_{buf}(0). The AP_1 122 may utilize the AID value AID=0 to indicate that the buffered frame EF_{buf}(0) is to be broadcast to each of the STAs, for example STA_A 124 and STA_B 126, within the BSS_1 112.

At determined time intervals, the AP_1 122 may broadcast beacon frames to the STA_A 124 and STA_B 126. When the STA_A 124 is in PS mode, the STA_A 124 may leave the doze state to enable reception of the transmitted beacon frames. The beacon frames may comprise a TIM information element, which may comprise an indication that the AP_1 122 is currently buffering data for delivery to the STA_A 124. The indication may be contained within a PVB field within the TIM element. The indication may be located within the PVB field based on the AID=1 association between the AP_1 122 and the STA_A 124.

Upon reception of the beacon frame, the STA_A 124 may inspect the PVB field within the TIM field and determine that the AP_1 122 is currently storing data for delivery to the STA_A 124. In response, the STA_A 124 may communicate a message to the AP_1 122 to request that the AP_1 122 deliver the buffered data to the STA_A 124. Upon receipt of the request from the STA_A 124, the AP_1 122 may send the buffered frame EF_{buf}(1) to the STA_A 124.

When the AP_1 122 has stored multicast or broadcast frames, the beacon frames may comprise a delivery TIM (DTIM) information element. The presence of the DTIM information element may be determined based on a value of the DTIM count within the TIM information element. In addition to the indication of buffered unicast frames, the DTIM information element may comprise an indication that the AP_1 122 may currently be buffering data for multicast or broadcast within the BSS_1 112. The indication of whether the AP_1 122 may currently be buffering one or more frames for multicast or broadcast may be contained within the PVB field. The indication may be located within the DTIM element based on the association identifier value AID=0.

Communications between the AP_2 132 and the STA_X 134 and STA_Y 136 within BSS_2 114 may be substantially similar to those described within BSS_1 112. In this aspect, the AP_2 132 may send beacon frames to the STA_X 134 and STA_Y 136. The TIM information element within the beacon frames may be generated based on the associations between the AP_2 132 and STA_X 134 and the AP_2 132 and STA_Y 136. Thus, the TIM information element sent within beacon frames transmitted by AP_1 122 may refer to STAs, STA_A 124 and STA_B 126, for which SSID=SSID₀ and BSSID=BSSID₁, while the TIM information element sent within beacon frames transmitted by AP_2 132 may refer to STAs, STA_X 134 and STA_Y 136, for which SSID=SSID₀ and BSSID=BSSID₂, for example.

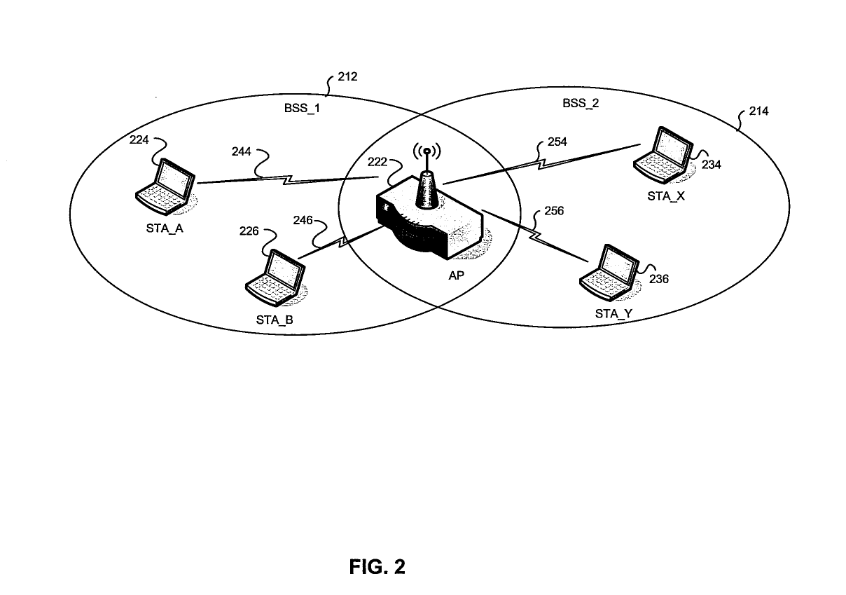

FIG. 2 is a block diagram illustrating an exemplary system for wireless data communication in which a single access point supports multiple basic service sets (BSSes), which may be utilized in connection with an embodiment of the invention. Referring to FIG. 2, there is shown a BSS_1 212, and a BSS_2 214. The BSS_1 212 comprises an AP 222, STA_A 224 and a STA_B 226. The BSS_2 214 comprises the AP 222, a STA_X 234 and a STA_Y 236.

Among WLAN systems, ESSes, BSSes and/or IBSSes may be physically collocated or partially overlapping. An AP or STA may be a member in one or more ESSs, BSSs and/or IBSSs. Each membership may be uniquely identified based on an SSID, BSSID and/or AID, for example. As shown in FIG. 2, the AP 222 is a member of the BSS_1 212 and of the BSS_2 214. The BSS_1 212 and BSS_2 214 may be members of a common ESS, or may be members of different ESSs. When the BSS_1 212 and BSS_2 214 are members of different ESSs, each ESS may be identified by a distinct SSID value. The BSS_1 212 may be identified by a BSSID=BSSID₁, for example. Within the BSS_1 212, the association between the STA_A 224 and the AP 222 may be identified by an AID=7, for example. The association between the STA_B 226 and the AP 222 may be identified by an AID=8, for example. Within the BSS_2 214, the association between the STA_X 234 and the AP 222 may be identified by an AID=9, for example. The association between the STA_Y 236 and the AP 222 may be identified by an AID=10, for example.

Once the AP 222 has established associations between STA_A 224 and STA_B 226, STA_X 234 and STA_Y 236 the AP 222 may enable communication between STA_A 224 and/or STA_B 226 within BSS_1 212 and STA_X 234 and/or STA_Y 236 within BSS_2 214. In addition, if BSS_1 212 and BSS_2 214 belong to the same ESS, the AP may enable communications between STAs in these two BSSes. For example, if the STA_X 234 sends a frame to the AP 222 for which the destination address identifies STA_A 224, the AP 222 may send the frame to STA_A 224. As described in FIG. 1, the AP 222 may buffer frames when the destination STA is operating in a PS mode.

Various embodiments of the invention may comprise a method and system by which the AP 222 may communicate that there are stored frames for delivery to one or more of a plurality of BSSes. In the beacon frame transmitted at the determined time intervals, the AP may include a TIM (DTIM) element that contains buffered frame indications for STAs associated with different BSSes. When the DTIM count is not equal to 0, the beacon frames comprise a TIM element, which may be used by the AP to indicate the presence of buffered unicast frames to stations associated with different BSSes. When the DTIM count is equal to 0, the beacon frames comprise a DTIM element, which may be used by the AP to indicate the presence of buffered broadcast and multicast frames in addition to indicating the presence of buffered unicast frames.

In this aspect of the invention, the AP 222 may broadcast beacon frames to STAs within the BSS_1 212 and to STAs within the BSS_2 214. When the beacon frames contain a TIM information element, a STA may inspect the indication contained within the TIM information element to determine whether the AP 222 is currently storing one or more unicast frames destined for the STA based on the value of a bit in the bitmap whose index corresponds to the STA's AID. When the beacon frames contain a DTIM information element, STAs within each BSS may inspect the indications contained within the DTIM information element to determine whether the AP 222 is currently storing frames for multicast or broadcast to the BSS based on the value of a bit in the bitmap whose index is associated with the BSS. A STA may also inspect the indications contained within the DTIM information element to determine whether the AP 222 is currently storing unicast frame destined for the STA based on the value of the bit in the bitmap whose bit index corresponds to the STA's AID.

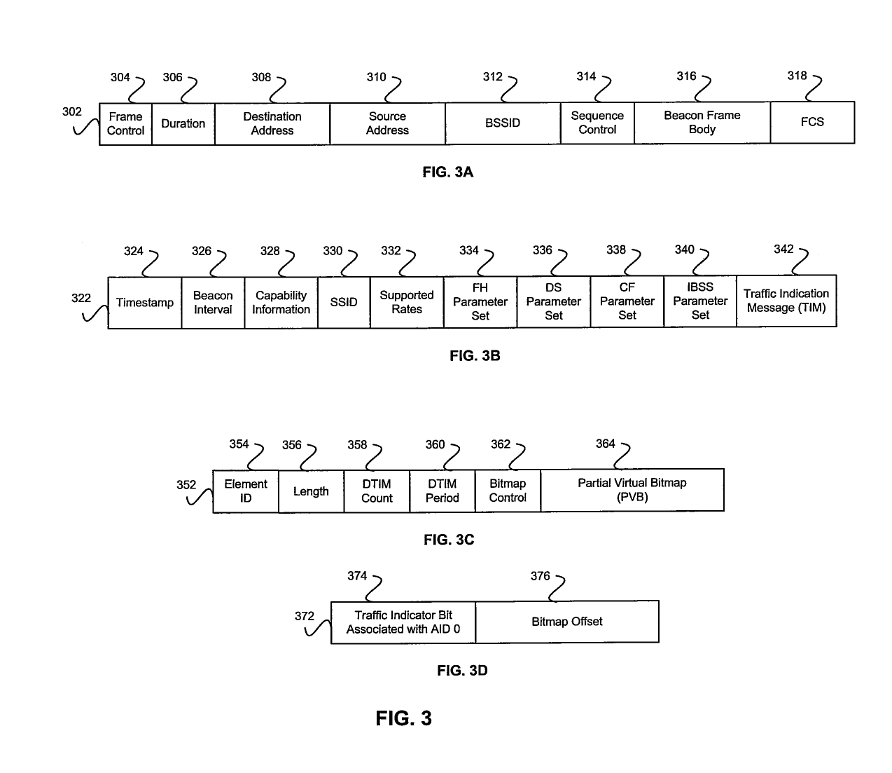

FIG. 3A is a block diagram for an exemplary beacon frame format, which may be utilized in connection with an embodiment of the invention. With reference to FIG. 3A there is shown a beacon frame format 302. The beacon frame 302 may comprise a frame control field 304, a duration field 306, a destination address field 308, a source address field 310, a BSSID field 312, a sequence control field 314, a beacon frame body 316, and a frame check sequence (FCS) 318.

The frame control field 304 may comprise information that identifies the frame as being a beacon frame. The duration field 306 may comprise a value, which is computed based on the data rate at which the beacon frame 302 is transmitted. The destination address field 308 may identify one or more STAs, which are intended to receive the beacon frame 302. The source address field 310 may identify the AP, which transmitted the beacon frame 302. The BSSID field 312 may contain the BSSID value of one BSS among a plurality of BSSes to which the beacon frame is being directed. The sequence control field 314 may be utilized to indicate whether the frame 302 is a segment within a larger beacon frame. The beacon frame body 316 may comprise information that is specific to a beacon frame. In various embodiments of the invention, the beacon frame body 316 comprises a TIM information element, which in turn comprises a partial virtual bitmap (PVB). The FCS field 318 may be utilized to detect and/or correct bit errors in a beacon frame 302 received at a STA.

In operation, in various embodiments of the invention, the BSSID field 312 may be utilized when the beacon frame 302 comprises a TIM information element, which indicates that the AP is currently buffering frames for delivery to a specific STA. In various embodiments of the invention, the BSSID field 312 may not be utilized to determine for which BSSes, among a plurality of BSSs, the AP is currently storing multicast or broadcast frames.

FIG. 3B is a block diagram for an exemplary beacon frame body format, which may be utilized in connection with an embodiment of the invention. With reference to FIG. 3B, there is shown a beacon frame body format 322. The beacon frame body format 322 may comprise a timestamp field 324, a beacon interval field 326, a capability information field 328, an SSID field 330, a supported rates field 332, a frequency hopping (FH) parameter set field 334, a direct sequence spread spectrum parameter set field 336, a contention free (CF) parameter set field 338, an independent BSS (IBSS) parameter set field 340, a traffic indication map field 342.

The timestamp field 324 may indicate a time instant at which the beacon frame was transmitted. The timestamp value inserted into the timestamp field 324 may be determined based on a timing source utilized by the AP, which is transmitting the beacon frame. The beacon interval field 326 may indicate the amount of time that may transpire between beacon frame transmissions. The capability information field 328 may be used to communicate capabilities available at the AP, which is transmitting the beacon frame. The SSID field 330 may contain the SSID value that identifies the corresponding ESS to which one BSS, among a plurality of BSSes to which the beacon frame is being directed, belongs. The supported rates field 332 may indicate data rates that may be supported by the AP, which is transmitting the beacon frame. The FH parameter set field 334 may comprise information, which enables STAs receiving the beacon frame to utilize frequency hopping when communicating with the AP that is transmitting the beacon frame. The DH parameter set field 338 may comprise information, which enables RF channel assignment to STAs when communicating with the AP. The CF parameter set field 340 may comprise information, which enables the AP that is transmitting the beacon frame to perform contention free polling of STAs, which are associated with the AP. The IBSS parameter set 340 may comprise information, which may be utilized by a STA within an IBSS. The TIM information element 342 comprises information, which may enable an AP to indicate to STAs that data is buffered at the AP for delivery to one or more STAs.

FIG. 3C is a block diagram for an exemplary traffic indication map information element, which may be utilized in connection with an embodiment of the invention. With reference to FIG. 3C, there is shown a traffic indication map (TIM) information element (IE) 352. The TIM IE 352 may comprise an element identifier (ID) field 354, a length field 356, a DTIM count field 358, a DTIM period 360, a bitmap control field 362 and a PVB field 364. The element ID field 354 may identify the TIM IE. The length field 356 may specify the total length (as measured in octets, for example) of the DTIM count 358, DTIM period 360, bitmap control 362 and PVB field 364. The DTIM count field 358 may indicate how many more beacon frames may be transmitted (including the current beacon frame) before a beacon frame is transmitted that comprises a DTIM. For example, a DTIM count value of 0, within the DTIM count field 358, may indicate that the current beacon frame comprises a DTIM. The DTIM period field 360 may indicate the interval between transmissions of beacon frames comprising a DTIM. For example, a value of 1 in the DTIM period field 360 may indicate that each transmitted beacon frame comprises a DTIM.

FIG. 3D is a block diagram for an exemplary bitmap control field, which may be utilized in connection with an embodiment of the invention. Referring to FIG. 3D, there is shown an exemplary bitmap control field 372. The bitmap control field 372 may comprise a traffic indication bit associated with AID 0 374 and a bitmap offset field 376. The bitmap control field 372 may comprise a traffic indicator bit 370, which enables an AP transmitting the beacon frame to indicate that one or more broadcast and/or multicast frames destined for one or more of the BSSes are currently buffered pending transmission at the AP. The bitmap control field 372 may also comprise a bitmap offset 376, which enables the AP to generate a PVB based on a traffic indication virtual bitmap. The bitmap offset 376 may also enable a STA to interpret the received PVB 364. The PVB field 364 may enable the AP to indicate that one or more frames are currently buffered pending transmission at the AP. The buffered frames may comprise frames for broadcast or multicast to a plurality of STAs within one or more BSSes, or frames for unicast to specific STAs within specific BSSes.

Various embodiments of the invention may comprise a method for encoding the PVB field 364 to indicate the presence of buffered frames pending transmission to one or more BSSes. Another aspect of the invention may comprise setting the bitmap offset value 376 within the bitmap control field 362, which enables coding of the PVB field utilizing fewer bits than in various conventional methods. The bitmap offset value 376 may also enable decoding of the PVB by a STA. This may enable a reduction in the length of the TIM IE 352, which may enable a reduction in the length of the beacon frame body 322, which in turn may enable a reduction in the length of the beacon frame 302. This may result in reduced power consumption at WLAN STAs, such as STA_A. In addition, various embodiments of the invention may enable a reduction in transmission time for transmitting the beacon frames 302. This may in turn allow a greater allocation of time available via the wireless communication medium for transmission of user data traffic. This in turn may increase data throughput performance among STAs in a WLAN.

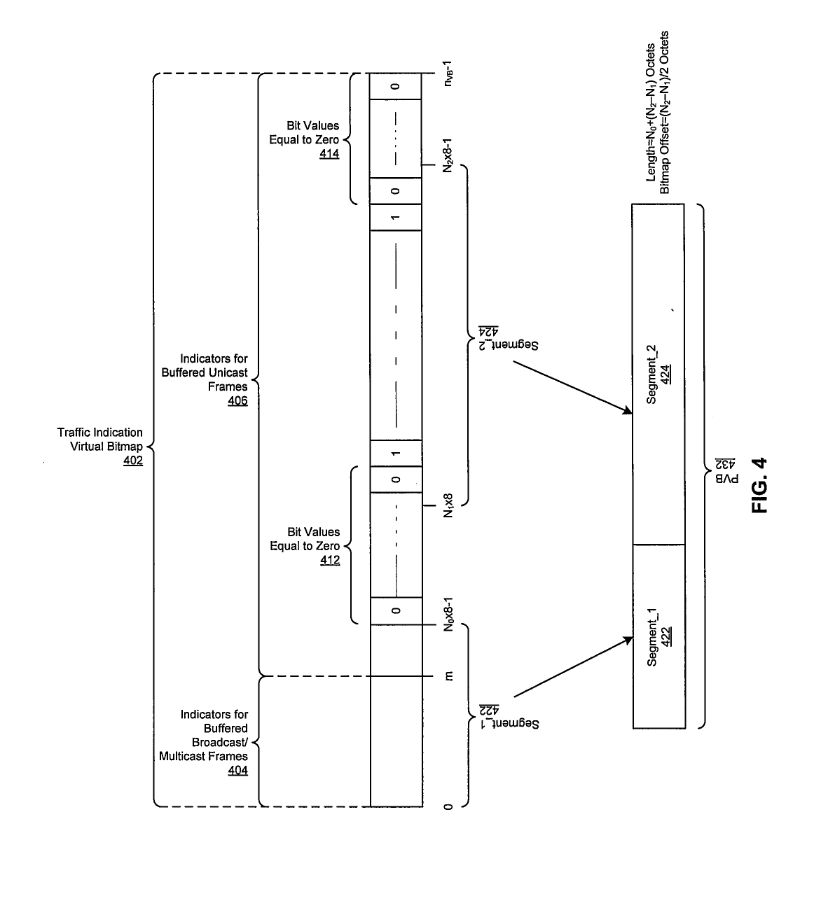

FIG. 4 is a diagram illustrating exemplary generation of a partial virtual bitmap for an access point, which has buffered unicast frames but may or may not have buffered broadcast/multicast frame, in accordance with an embodiment of the invention. Referring to FIG. 4, the AP 222 may generate a traffic indication virtual bitmap 402. The traffic indication virtual bitmap 402 may comprise a plurality of indicators for buffered broadcast and multicast frames 404, and a plurality of indicators for buffered unicast frames 406. The plurality of indicators for buffered unicast frames 406 may comprise a first contiguous set of bit values equal to zero 412, and a second contiguous set of bit values equal to zero 414.

In an exemplary embodiment of the invention, the indicators for buffered broadcast and multicast frames 404 enable the AP 222 to indicate for which BSSes, among a plurality of BSSes, the AP 222 may currently be buffering broadcast and multicast frames pending transmission. The broadcast and multicast traffic indicators field 404 may comprise a plurality of the first m contiguous bits, wherein the value m is determined based on the number of BSSes, which are supported by the AP 222. In this aspect of the invention, one bit among the m-bit broadcast/multicast traffic indicator field 404 may be used to indicate whether the AP 222 has buffered broadcast and multicast frames destined to a specific BSS. The value of m may be communicated by the AP 222 to STAs via an information element included in beacon frames, and/or probe response frames and/or other management frames. Alternatively, the value of m may be inferred by the STAs. In this aspect of the invention, the AP may generate and communicate to STAs an index value assigned to the corresponding BSS.

In an exemplary embodiment of the invention, the indicators for buffered unicast frames 406 enable the AP 222 to indicate for which STAs, among a plurality of STAs, the AP 222 is currently buffering frames pending transmission. The STAs may be identified based on the AID assigned to the STA. In various embodiments of the invention, the traffic indication virtual bitmap 402 may comprise n_{VB} bits, and the indicators field 406 may comprise (n_{VB}−m) bits. In an exemplary aspect of the invention, one bit may be allocated among the (n_{VB}−m)-bit field 406 to identify each STA. A bit which may be assigned to a specific STA may be indexed within the (n_{VB}−m) bits based on the AID assigned to the STA.

In an exemplary embodiment of the invention in which the AP 222 is currently buffering multicast or broadcast frames pending transmission to a plurality of BSSes, may currently be buffering unicast frames pending transmission to a plurality of STAs, a PVB 432 may be generated based on the traffic indication virtual bitmap 402, wherein the PVB 432 comprises fewer than n_{VB} bits. A value N₀, may be determined such that N₀×8≧m (where the first bit in the bitmap 402 is located at bit position 0). Based on the value N₀, a segment_1 422 may be generated, which comprises the range of bit positions from 0 to N₀×8−1 in the bitmap 402. Subsequently, a value N₁>N₀ may be determined such that each of the bits across the range of bit positions, from N₀×8 to N₁×8−1 in the bitmap 402, is equal to 0, wherein at least one bit in the (N₁+1)^{th} or the (N₁+2)^{th} octet in the bitmap 402 has a value equal to 1. If such a value N₁>N₀ does not exist, N₁ may be chosen to be equal to N₀. Next, a value N₂>N₁ may be determined, which is the smallest integer value for which the values for each of the bits across the range of bit positions, from N₂×8 to n_{VB}−1 in the bitmap 402, is equal to 0. Such a value N₂ does not exist when not all the bits in the last octet of the traffic indication virtual bitmap are equal to 1, subsequently, N₂ may be chosen to be equal to N_{vB}/8. Based on the values N₁ and N₂, a segment_2 424 may be generated, which comprises the range of bit positions from N₁×8 to (N₂×8−1) in the bitmap 402.

In a preferred embodiment of the invention, the selection of N₀ may minimize the length of segment_1, the selection of N₁ may maximize the length of the separation between segment_1 and segment_2, and the selection of N₂ may minimize the length of segment_2. The selection of N₀, N₁ and N₂ may minimize the length of the PVB 364.

In an exemplary embodiment of the invention, the length of the separation between segment_1 and segment_2 may be an even number of octets.

In an exemplary embodiment of the invention, a value N₀ may be determined such that N₀ is the smallest positive integer such that N₀×8−m≦8 (where the first bit in the bitmap 402 is located at bit position 0). If N₀ is an odd number, then N₁ is the largest odd number such that each of the bits N₀×8 to (N₁×8−1) is equal to zero. When N₀ is an even number, then N₁ is the largest even number such that each of the bits N₀×8 to (N₁×8−1) is equal to zero. If such a value N₁>N₀ does not exist, N₁ may be chosen to be equal to N₀.

In an alternative exemplary embodiment of the invention, a value N₀ and a value N₁ may be determined, using one of the following exemplary options, such that each of the bits across the range of bit positions, from m to N₀×8−1 in the bitmap 402, is equal to 0 (where the first bit in the bitmap 402 is located at bit position 0). In various embodiments of the invention, exemplary methods used to determine the values of N₀ and N₁, N₀≧1 and the resulting value (N₁−N₀) may be either a positive even number or zero.

In one exemplary option, first select N₀ where N₀ may be the smallest positive integer number such that each of the bits m to (N₀×8−1) is equal to zero. Subsequently, a value N₁ may be selected. If N₀ is an odd number, then N₁ is the largest odd number such that each of the bits m to (N₁×8−1) is equal to zero. When N₀ is an even number, for example, then N₁ is the largest even number such that each of the bits m to (N₁×8−1) is equal to zero.

In another exemplary option, first select N₁ where N₁ may be the largest integer number such that each of the bits m to (N₁×8−1) is equal to zero. Subsequently, a value N₀ may be selected. When N₁ is an odd number, for example, then N₀ is the smallest positive odd number such that each of the bits m to (N₀×8−1) is equal to zero. When N₁ is an even number, then N₀ is the smallest positive even number such that each of the bits m to (N₀×8−1) is equal to zero.

In another exemplary option, first a value N₁ may be selected where N₁ is the largest even number such that each of the bits m to (N₁×8−1) is equal to zero. Subsequently, a value N₀ may be selected where N₀ is the smallest positive even number such that each of the bits m to (N₀×8−1) is equal to zero.

In another exemplary option, first a value N₁ may be selected where N₁ is the largest odd number such that each of the bits m to (N₁×8−1) is equal to zero. Subsequently, a value N₀ may be selected where N₀ is the smallest positive odd number such that each of the bits m to (N₀×8−1) is equal to zero.

In another exemplary option, first a value N₀ may be selected where N₀ may be the smallest positive even number such that each of the bits m to (N₀×8−1) is equal to zero. Subsequently, a value N₁ may be selected where N₁ is the largest even number such that each of the bits m to (N₁×8−1) is equal to zero.

In another exemplary option, first a value N₀ may be selected where N₀ is the smallest positive odd number such that each of the bits m to (N₀×8−1) is equal to zero. Subsequently, a value N₁ may be selected where N₁ is the largest odd number such that each of the bits m to (N₁×8−1) is equal to zero.

In an exemplary embodiment of the invention, based on the value N₀, a segment_1 422 may be generated, which comprises the range of bit positions from 0 to N₀×8−1 in the bitmap 402.

Next, a value N₂>N₁ may be determined, which is the smallest integer value for which the values for each of the bits across the range of bit positions, from N₂×8 to n_{VB}−1 in the bitmap 402, is equal to 0. Such a value N₂ does not exist when not all the bits in the last octet of the traffic virtual indication bitmap are equal to 0, subsequently, N₂ may be chosen to be equal to N_{vB}/8. Based on the values N₁ and N₂, a segment_2 424 may be generated, which comprises the range of bit positions from N₁×8 to (N₂×8−1) in the bitmap 402.

A PVB 432 may be generated by combining segment_1 422 and segment_2 424. The length of the PVB 432 may be computed (in octet units) as shown in the following equation:

Length=N₀+(N₂−N₁) [1]

An offset value, which represents the number of bit positions between the segment_1 422 and the segment_2 424 in the bitmap 402, may be computed as shown in the following equation:

Offset=N₁−N₀ [2]

In various embodiments of the invention, a TIM IE 352 may be generated wherein the PVB 364 may comprise the PVB 432, and the bitmap offset 376 within the bitmap control field 362 may comprise a value based on the offset computed in equation [2]. For example, in an exemplary embodiment of the invention the bitmap offset value, BitmapOffset, may be determined as shown in the following equation:

$$BitmapOffset = \frac{{N}_{1} - {N}_{0}}{2} \qquad [ 3 ]$$

The AP 222 may or may not communicate the value of N₀ to the STAs. The communication of the value N₀ may be achieved via an information element included in beacon frames, and/or probe response frames and/or other management frames. If the value of N₀ is not communicated by the AP 222, the STAs may infer the value N₀ from the value m.

In various embodiments of the invention, if the DTIM count is equal to 0, based on the interpretation of the received PVB 432, the STA may determine whether the AP 222 may currently be buffering multicast and/or broadcast frames pending delivery to the BSS to which the STA is a member. In this aspect of the invention, the AP may generate, and communicate to STAs, an index value assigned to the corresponding BSS. The STA may utilize this index to identify a bit among the first m bits in the PVB 432. Based on the value of the identified bit, the STA may determine whether the AP 222 may currently be buffering multicast and/or broadcast frames.

In various embodiments of the invention, regardless of the value of the DTIM count, a STA receiving a beacon frame, which comprises the PVB 432, may also determine whether it has buffered unicast frames at the AP 222 based on the value N₀, the bitmap offset value 376, and the PVB 432. The STA may determine the value of N₁ as follows:

N₁=2×BitmapOffset+N₀ [4]

Subsequently, the STA may determine the value of N₂ as follows:

$${N}_{2} = 2 \times BitmapOffset + \frac{{n}_{P V B}}{8} \qquad [ 5 ]$$

where n_{PVB} indicates the number of bits in the PVB 432.

Given the values of N₀, N₁ and N₂, the STA may use its AID value to determine whether there are unicast frames being buffered at the AP 222 pending transmission.

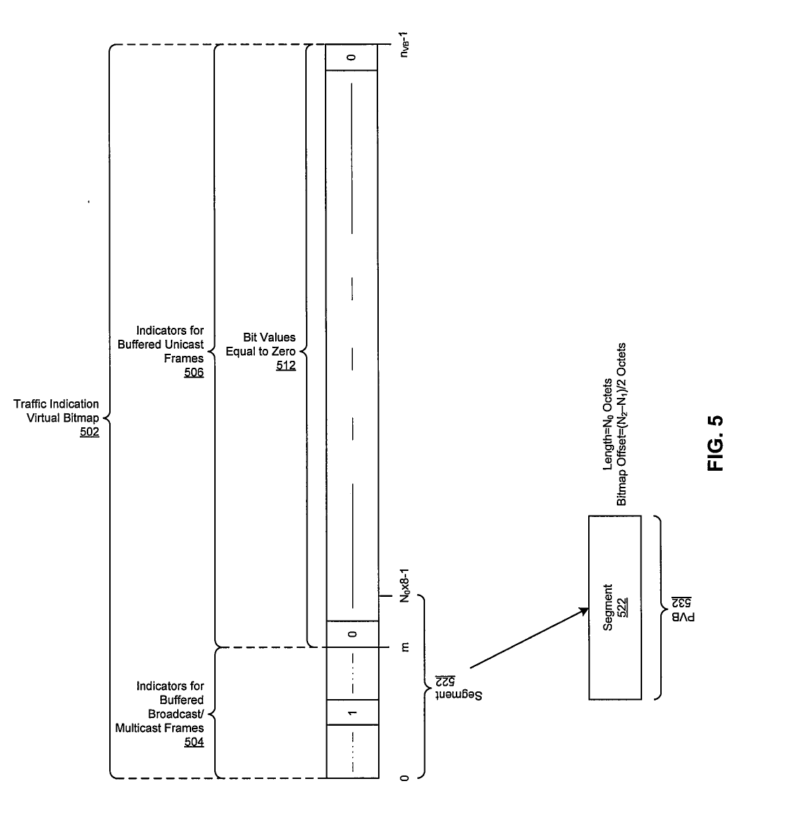

FIG. 5 is a diagram illustrating exemplary generation of a partial virtual bitmap for an access point, which has buffered broadcast/multicast frames but has no buffered unicast frames, in accordance with an embodiment of the invention. Referring to FIG. 5, the AP 222 may generate a traffic indication virtual bitmap 502. The traffic information virtual bitmap 502 may comprise a plurality of indicators for buffered broadcast and multicast frames 504, and a plurality of indicators for buffered unicast frames 506. The plurality of indicators for buffered unicast frames 506 may comprise a contiguous set of bit values equal to zero 512.

In an exemplary embodiment of the invention, a value N₀ may be determined such that N₀ is the smallest positive integer such that (N₀×8−m)≦8 (where the first bit in the bitmap 502 is located at bit position 0). Based on the value N₀, a segment 522 may be generated, which comprises the range of bit positions from 0 to N₀×8−1 in the bitmap 502.

Since the values of the remaining bits in the bitmap 502 are equal to 0, the PVB 532 may be generated based on the segment 522. The length of the PVB 532 may be computed (in octet units) as shown in the following equation:

Length=N₀ [6]

Since the PVB 532 comprises a single contiguous set of bits from the bitmap 502, the bitmap offset value 376 may be equal to 0.

In various embodiments of the invention, a TIM IE 352 may be generated wherein the PVB 364 may comprise the PVB 532, and the bitmap offset 376 within the bitmap control field 362 may comprise a value equal to 0.

In various embodiments of the invention, the AP may or may not communicate the value N₀ to the STAs. The communication of the value N₀ may be achieved via an information element included in beacon frames, and/or probe response frames and/or other management frames. If the value of N₀ is not communicated by the AP 222, the STAs may infer the value N₀ from the value m.

In various embodiments of the invention, if the DTIM count is equal to 0, based on the interpretation of the received PVB 532, the STA may determine whether the AP 222 may currently be buffering multicast and/or broadcast frames pending delivery to the BSS to which the STA is a member. In this aspect of the invention, the AP may generate, and communicate to each STA, an index value assigned to the BSS to which the receiving STA is a member. The STA may utilize this index to identify a bit among the first m bits in the PVB 532. Based on the value of the identified bit, the STA may determine whether the AP 222 may currently be buffering multicast and/or broadcast frames.

In various embodiments of the invention, a STA that receives a beacon frame, which comprises the PVB 522, may utilize the values N₀, N₁ and N₂ and the AID value assigned to the STA to determine, regardless of the value of the DTIM count, whether there are unicast frames being buffered at the AP 222 pending transmission. The values of N₁ and N₂ may be determined using equations [4] and [5], respectively.

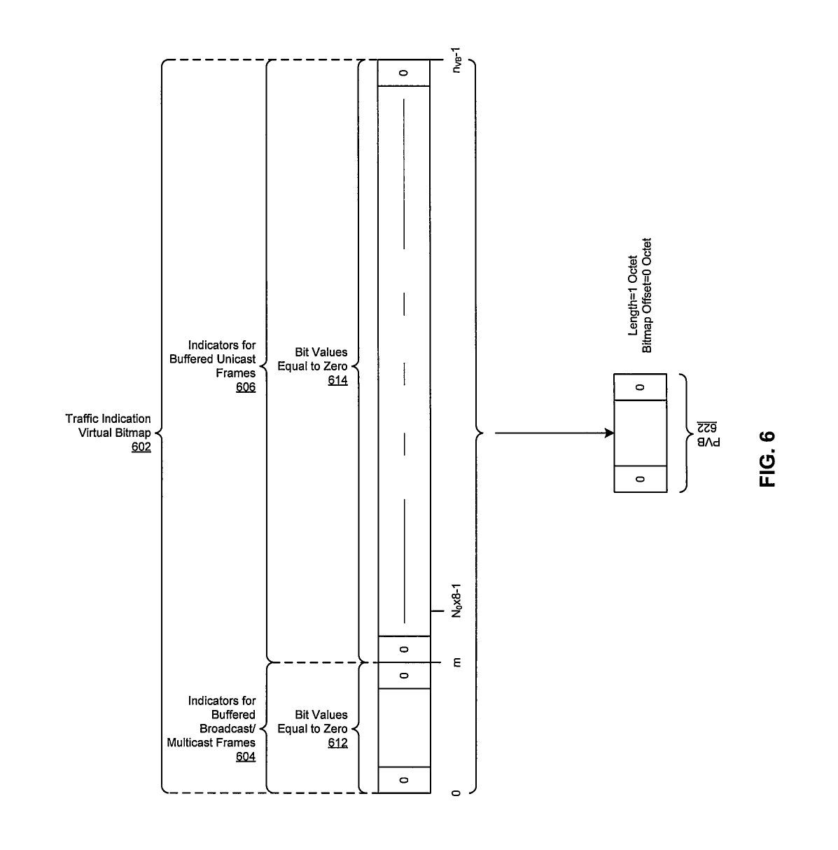

FIG. 6 is a diagram illustrating exemplary generation of a partial virtual bitmap for an access point, which has no buffered frames, in accordance with an embodiment of the invention. Referring to FIG. 6, the AP 222 may generate a traffic indication virtual bitmap 602 (where the first bit in the bitmap 602 is located at bit position 0). The traffic information virtual bitmap 602 may comprise a plurality of indicators for buffered broadcast and multicast frames 604, and a plurality of indicators for buffered unicast frames 606. The plurality of indicators for buffered broadcast and multicast frames 604 may comprise a contiguous set of bit values equal to zero 612. The plurality of indicators for buffered unicast frames 606 may comprise a contiguous set of bit values equal to zero 614.

In an exemplary embodiment of the invention, a PVB 622 may be generated based on the bitmap 602. The PVB 622 wherein the length of the PVB 622 is one octet. The value of each of the bits in the PVB 622 may be equal to 0. A bitmap offset value 376 may be computed to be equal to 0.

In an exemplary embodiment of the invention, in which the AP 222 has no buffered frames, a TIM IE 352 may be generated wherein the PVB 364 comprises the PVB 622. The bitmap offset within the bitmap control field 362 may comprise a value equal to 0.

In various embodiments of the invention, a STA receiving a beacon frame, which comprises the PVB 622, may determine that there is no buffered frames at the AP 222.

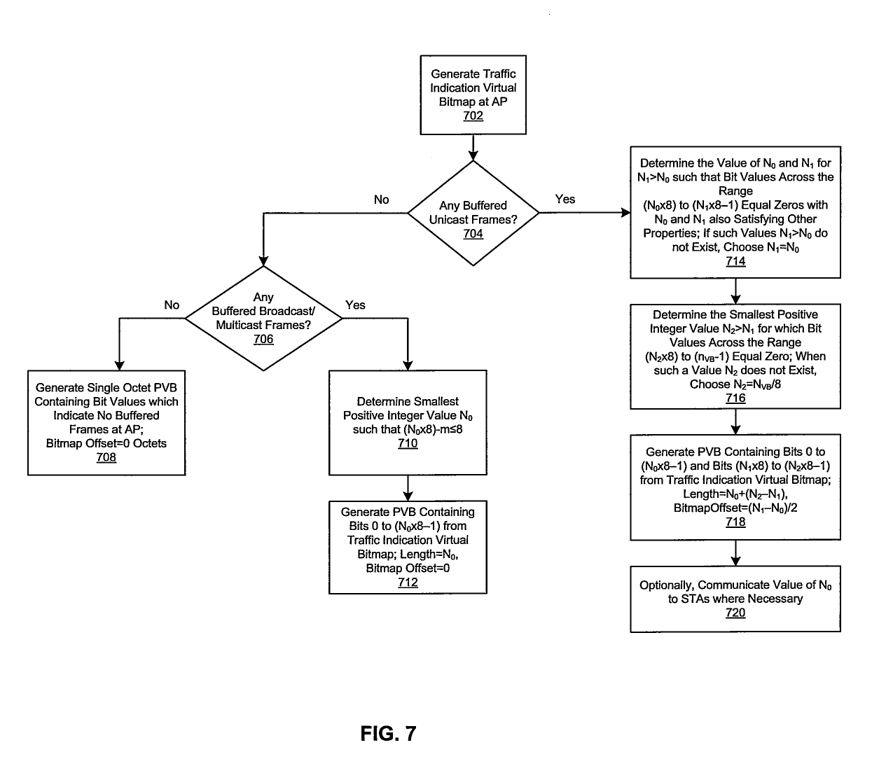

FIG. 7 is a flowchart illustrating exemplary steps for the construction of an efficient TIM element supporting multiple BSSes in a WLAN, in accordance with an embodiment of the invention. Referring to FIG. 7, in step 702, the AP 222 may generate a traffic indication virtual bitmap.

Prior to generating a TIM IE, in step 704, the AP 222 may determine whether there are any buffered unicast frames. When it is determined in step 704 that there are no buffered unicast frames, in step 706, the AP 222 may determine whether there are any buffered broadcast or multicast frames. When it is determined in step 706 that there are no buffered broadcast or multicast frames, in step 708, the AP 222 may generate a PVB 622 of a single octet for which the value for each of the bits is equal to 0. The Bitmap Offset 376 may be set to 0. The PVB 622 may indicate that there are no buffered frames in the AP 222.

When it is determined in step 706 that there are buffered broadcast or multicast frames, in step 710, the AP 222 may determine N₀ to be the smallest positive integer value such that (N₀×8−m)≦8 (where the first bit in the traffic indication virtual bitmap is located at bit position 0). In step 712, the AP may generate a PVB containing bits across the range of bit positions, from 0 to N₀×8−1 in the in the traffic indication virtual bitmap. The length of the PVB may be equal to N₀ octets, and a computed Bitmap Offset 376 may be equal to 0 octets.

When it is determined in step 704 that there are buffered unicast frames, in step 714, the AP 222 may determine the value N₀ and N₁ using a number of exemplary methods such as the aforementioned methods, for example (where the first bit in the traffic indication virtual bitmap is located at bit position 0). The resulting value (N₁−N₀) may be either an even number or zero. When some selection methods for N₀ are used, each of the bits across the range of bit positions, from m to N₀×8−1 in the traffic indication virtual bitmap, may not be equal to 0. Alternatively, if some other selection methods for N₀ are used, all the bits across the range of bit positions, from m to N₀×8−1 in the traffic indication virtual bitmap, may be equal to 0. Independent of the selection method for N₀, When N₁>N₀, each of the bits across the range of bit positions, from N₀×8 to N₁×8−1 in the traffic indication virtual bitmap, may be equal to 0, wherein at least one bit in the (N₁+1)^{th} or the (N₁+2)^{th} octet in the traffic indication virtual bitmap has a value equal to 1. When N₁=N₀, the bitmap offset 376 is equal to 0. In step 716, the AP 222 may determine a value N₂>N₁ for which the values for each of the bits across the range of bit positions, from N₂×8 to n_{VB}−1 in the traffic indication virtual bitmap, is equal to 0. When such a value N₂ does not exist (that is, when not all the bits in the last octet of the traffic indication virtual bitmap are equal to 0), N₂ may be chosen to be equal to N_{VB}/8. In step 718, the AP 222 may generate a PVB containing bits from bit positions 0 to N₀×8−1 and bit positions N₁×8 to N₂×8−1 in the traffic indication virtual bitmap. The length of the PVB may be as computed in equation [1] and the Bitmap Offset 376 may be as computed in equation [3]. Optionally, in step 720, the AP 222 may communicate the value of N₀ to STAs.

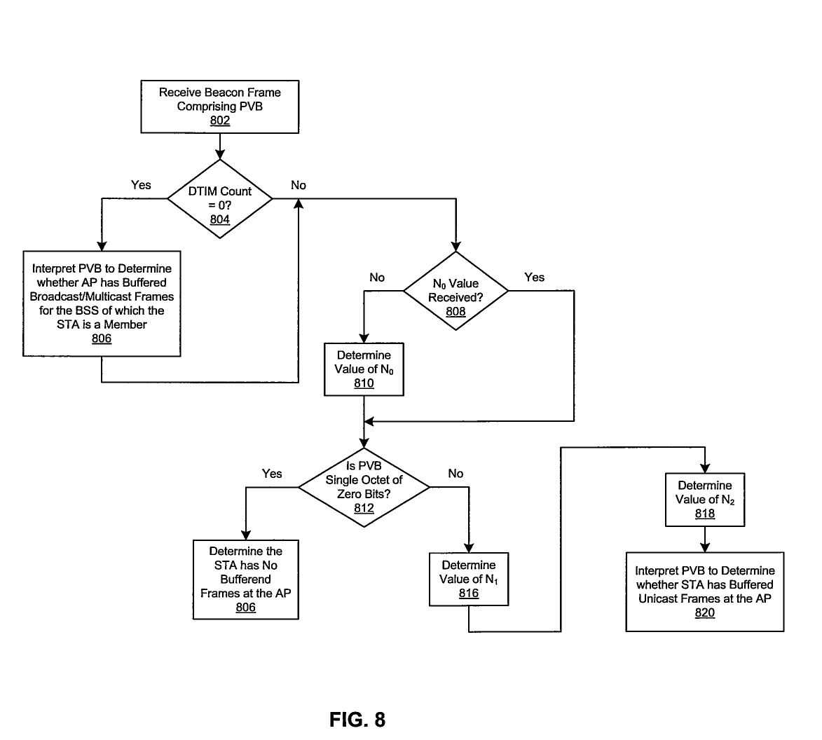

FIG. 8 is a flowchart illustrating exemplary steps for the interpretation of a TIM or DTIM element from a received beacon frame and determination of whether a STA has buffered frames at an AP, in accordance with an embodiment of the invention. In FIG. 8, the STA receiving the beacon frame may have been notified by the AP 222 of the value m. The STA receiving the beacon may or may not additionally be notified by the AP 222 of the value of N₀. Referring to FIG. 8, in step 802, the STA may receive a beacon frame that comprises a PVB 364. In step 804, the STA may determine whether the value of the DTIM count in the TIM element is zero. If the DTIM count is equal to 0, the STA may perform step 806 to determine whether the AP 222 has buffered broadcast/multicast by inspecting the value of the bit whose bit location corresponds to the BSS of which the STA is a member. In step 808, the STA may determine whether the value of N₀ has been received. If the value N₀ has not been received, in step 810, the STA may determine the value N₀ based on the value m. In step 812, the STA may inspect the received PVB 364. If the PVB 364 is a single octet in which the value of each bit is equal to zero, the STA may perform step 814 where the STA may determine that there are no buffered frames at the AP 222. Otherwise, the STA may perform step 816, in which to the STA determines the value of N₁, which is equal to N₀+2×BitmapOffset. In step 818, the STA may determine the value of N₂ where N₂ equals the sum of n_{PVB}/8 and 2×BitmapOffset. In step 820, the STA may use the values of N₀, N₁, N₂ and its AID to determine whether the AP 222 has buffered unicast frames.

In various embodiments of the invention, step 808, step 810, step 812, step 814, step 816, step 818 and step 820 may be performed after step 802. Furthermore, in various embodiments of the invention, step 804 and 806 may be performed after step 820.

Aspects of a system for an efficient traffic indication map (TIM) element supporting multiple basic service sets (BSSes) in a wireless LAN may include an access point (AP) 222 the enables generation of a traffic indication virtual bitmap 402 based on the presence of stored data pending transmission to one or more WLAN stations (STAs) via a wireless communication medium. The AP 222 may generate a partial virtual bitmap (PVB) 432 based on the generated traffic indication virtual bitmap 402. The partial virtual bitmap (PVB) 432 may comprise a first segment 422 and a second segment 424, wherein each segment may be derived from the generated traffic indication virtual bitmap 402.

The first segment 422 may comprise a plurality of bits, which indicate the presence of stored frames for multicast and/or broadcast transmission to all the BSSes supported by the AP 222 and stored frames for unicast transmission to the associated STAs whose AIDs range from m to N₀×8−1. The second segment 424 may comprise a plurality of bits, which indicate the presence of stored frames for unicast transmission to the associated STAs whose AIDs range from N₁×8 to (N₂×8−1). The multicast and/or broadcast transmission may enable the stored frames to be communicated to a plurality of STAs via the wireless communication medium. The unicast transmission may enable the stored frames to be communicated to a specific STA 224 via the wireless communication medium.

The AP 222 may determine the number of bits used to indicate the presence of stored data for multicast and/or broadcast transmission in the generated traffic indication virtual bitmap 402. The AP may determine a first index value, m, which is used to index the last bit position, m, in the generated traffic indication bitmap 402. The value m may be equal to the total number of bits used in the traffic indication virtual bitmap 402 to indicate presence of stored data for multicast and/or broadcast transmission for multiple BSSes supported by the AP 222. The AP 222 may determine a second index value, N₀×8>m, which indexes a second bit position within the generated traffic indication virtual bitmap 402. The second index value, N₀×8−1, may be less than 8 but greater than the value of the first index value, m. The first segment 422 may be generated based on the value N₀×8.

The AP 222 may generate a third index value, N₁×8>N₀×8, which indexes a third bit position within the generated traffic indication bitmap 402. The bit value for each of the bits in the range of bit positions from bit position N₀×8 to N₁×8−1 may be equal to 0. The bit value of at least one bit, which is less than 8 or 16 bit positions subsequent to the third bit position, N₁×8, may be equal to 1.

The AP 222 may generate a fourth index value, N₂×8>N₁×8, which indexes a fourth position within the generated traffic indication virtual bitmap 402. The bit value of at least one bit, which is not more than 8 bit positions previous to the fourth bit position, N₂×8, may be equal to 1. The bit value of each bit, in the range of bit positions including and subsequent to the fourth bit position N₂×8, may be equal to 0. The second segment 424 may be generated based on the third index value, N₁×8, and the fourth index value N₂×8.

The AP may communicate the value of m to STAs via an information element included in beacon frames, and/or probe response frames and/or other management frames.

The AP may or may not communicate the value of N₀ to STAs via an information element included in beacon frames, and/or probe response frames and/or other management frames. In various embodiments of the invention, the bits used to indicate the presence of buffered broadcast and multicast frames may not reside in the first m bit positions of the traffic indication virtual bitmap. Instead, the bits used to indicate the presence of buffered broadcast and multicast frames may be interspersed throughout the traffic indication virtual bitmap. The value m may not be used in the construction and the interpretation of the PVB. However, the value of N₀ may be communicated by the AP to the STAs and the values of N₀, N₁ and N₂ may be used in the same fashion.

Another embodiment of the invention may provide a machine-readable storage, having stored thereon, a computer program having at least one code section executable by a machine, thereby causing the machine to perform the steps as described herein for an efficient traffic indication map (TIM) element supporting multiple basic service sets (BSSes) in a wireless LAN.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communicating data, the method comprising:
generating a traffic indication virtual bitmap based on the presence of stored data that is pending transmission via at least a wireless communication medium; and
generating a partial virtual bitmap based on said generated traffic indication virtual bitmap, wherein;
said partial virtual bitmap comprises a first segment from said generated traffic indication virtual bitmap and a second segment from said generated traffic indication virtual bitmap.

2. The method according to claim 1, wherein said first segment comprises a plurality of bits, which indicate the presence of stored data for multicast and/or broadcast transmission to a plurality of basic service sets as well as the presence of stored data for unicast transmission to one of a subset of stations associated to a plurality of basic service sets within a wireless network.

3. The method according to claim 2, wherein said multicast and/or broadcast transmission enables said stored data to be communicated to a plurality of receiving stations and said unicast transmission enables said stored data to be communicated to a specific receiving station via said wireless communication medium.

4. The method according to claim 1, wherein said second segment comprises a plurality of bits, which indicate the presence of stored data for unicast transmission to one of a subset of stations associated to a plurality of basic service sets.

5. The method according to claim 4, wherein said unicast transmission enables said stored data to be communicated to a specific receiving station via said wireless communication medium.

6. The method according to claim 1, comprising determining the number of bits in said generated traffic indication virtual bitmap, which indicate the presence of stored data for multicast and/or broadcast transmission.

7. The method according to claim 6, comprising determining a first index value, which indexes a last bit position in said generated traffic indication virtual bitmap, which indicates the presence of said stored data for said multicast and/or broadcast transmission.

8. The method according to claim 7, comprising determining a second index value, greater than said first index value, which indexes a second bit position within said generated traffic indication virtual bitmap.

9. The method according to claim 8, wherein said second index value is greater than said first index value by a number not greater than eight.

10. The method according to claim 8, wherein said second index value is greater than said first index value by a number not greater than sixteen.

11. The method according to claim 8, wherein said first segment is generated based on said second index value.

12. The method according to claim 8, comprising determining a third index value, greater than said second index value, which indexes a third bit position within said generated traffic indication virtual bitmap.

13. The method according to claim 12, wherein the bit value for each of the bits in the range of bit positions, from said second bit position to one bit position preceding said third bit position, is equal to zero.

14. The method according to claim 12, wherein the bit value of at least one bit, which is less than eight bit positions subsequent to said third bit position, is equal to one.

15. The method according to claim 12, wherein the bit value of at least one bit, which is less than sixteen bit positions subsequent to said third bit position, is equal to one.

16. The method according to claim 12, comprising determining a fourth index value, greater than said third index value, which indexes a fourth bit position within said generated traffic indication virtual bitmap.

17. The method according to claim 16, wherein the bit value of at least one bit, which is not more than eight bit positions previous to said fourth bit position, is equal to one.

18. The method according to claim 16, wherein the bit value of each bit, in the range of bit positions including and subsequent to said fourth bit position, is equal to 0.

19. The method according to claim 16, wherein said second segment is generated based on said third index value and said fourth index value.

20. A system for communicating data, the system comprising:
one or more circuits that enable generation of a traffic indication virtual bitmap based on the presence of stored data that is pending transmission via at least a wireless communication medium; and
said one or more circuits enable generation of a partial virtual bitmap based on said generated traffic indication virtual bitmap, wherein;
said partial virtual bitmap comprises a first segment from said generated traffic indication virtual bitmap and a second segment from said generated traffic indication virtual bitmap.

21. The system according to claim 20, wherein said first segment comprises a plurality of bits, which indicate the presence of stored data for multicast and/or broadcast transmission to a plurality of basic service sets as well as the presence of stored data for unicast transmission to one of a subset of stations associated to a plurality of basic service sets within a wireless network.

22. The system according to claim 21, wherein said multicast and/or broadcast transmission enables said stored data to be communicated to a plurality of receiving stations and said unicast transmission enables said stored data to be communicated to a specific receiving station via said wireless communication medium.

23. The system according to claim 20, wherein said second segment comprises a plurality of bits, which indicate the presence of stored data for unicast transmission to one of a subset of stations associated to a plurality of basic service sets.

24. The system according to claim 23, wherein said unicast transmission enables said stored data to be communicated to a specific receiving station via said wireless communication medium.

25. The system according to claim 20, wherein said one or more circuits enable determination of the number of bits in said generated traffic indication virtual bitmap, which indicate the presence of stored data for multicast and/or broadcast transmission.

26. The system according to claim 25, wherein said one or more circuits enable determination of a first index value, which indexes a last bit position in said generated traffic indication virtual bitmap, which indicates the presence of said stored data for said multicast and/or broadcast transmission.

27. The system according to claim 26, wherein said one or more circuits enable determination of a second index value, greater than said first index value, which indexes a second bit position within said generated traffic indication virtual bitmap.

28. The system according to claim 27, wherein said second index value is greater than said first index value by a number not greater than eight.

29. The system according to claim 27, wherein said second index value is greater than said first index value by a number not greater than sixteen.

30. The system according to claim 27, wherein said first segment is generated based on said second index value.

31. The system according to claim 27, wherein said one or more circuits enable determination of a third index value, greater than said second index value, which indexes a third bit position within said generated traffic indication virtual bitmap.

32. The system according to claim 31, wherein the bit value for each of the bits in the range of bit positions, from said second bit position to one bit position preceding said third bit position, is equal to zero.

33. The system according to claim 31, wherein the bit value of at least one bit, which is less than eight bit positions subsequent to said third bit position, is equal to one.

34. The system according to claim 31, wherein the bit value of at least one bit, which is less than sixteen bit positions subsequent to said third bit position, is equal to one.

35. The system according to claim 31, wherein said one or more circuits enable determination of a fourth index value, greater than said third index value, which indexes a fourth bit position within said generated traffic indication virtual bitmap.

36. The system according to claim 35, wherein the bit value of at least one bit, which is not more than eight bit positions previous to said fourth bit position, is equal to one.

37. The system according to claim 35, wherein the bit value of each bit, in the range of bit positions including and subsequent to said fourth bit position, is equal to 0.

38. The system according to claim 35, wherein said second segment is generated based on said third index value and said fourth index value.
